(19) United States
(12) Patent Application Publication
(10) Pub. No.: US 2017/0187110 A1
(43) Pub. Date: Jun. 29, 2017

(54) RADIO COMMUNICATION DEVICE AND BEAM CONTROL METHOD

(71) Applicant: FUJITSU LIMITED, Kawasaki-shi (JP)

(72) Inventor: Shunsuke FUJIO, Kawasaki (JP)

(73) Assignee: FUJITSU LIMITED, Kawasaki-shi (JP)

(21) Appl. No.: 15/384,683

(22) Filed: Dec. 20, 2016

(30) Foreign Application Priority Data
Dec. 24, 2015 (JP) 2015-252002

(51) Int. Cl. H01Q 3/38; H04W 16/28

(52) U.S. Cl. CPC H01Q 3/38; H04W 16/28

(57) ABSTRACT

A radio communication device including a memory and a processor coupled to the memory and the processor configured to determine a method, among a plurality of methods for beam forming, to be used for forming a first beam for a first terminal and a second beam for a second terminal based on a difference between an emitting direction of the first beam, to be formed, from the radio communication device and an estimated direction of the second terminal from the radio communication apparatus, the estimated direction being estimated based on a received signal from a second terminal, and form the first beam and the second beam based on the determined method.

### CROSS-REFERENCE TO RELATED APPLICATION

This application is based upon and claims the benefit of priority of the prior Japanese Patent Application No. 2015-252002, filed on Dec. 24, 2015, the entire contents of which are incorporated herein by reference.

### FIELD

The following disclosure relates to a radio communication device and a beam control method.

### BACKGROUND

In a high-frequency band, to compensate for a large propagation loss, a plurality of elements of an array antenna is controlled, and beam forming is performed. In addition, hybrid beam forming is drawing attention as a configuration for performing beam forming. In hybrid beam forming, each of a plurality of phased array antennas is treated as one subarray. Each of the plurality of phased array antennas is coupled to a digital signal processing circuit via different digital-to-analog converters (D/As).

Digital beam forming by a digital signal processing circuit can suppress interference of a radio signal sent by a beam directed to a certain terminal with a radio signal sent by a beam directed to another terminal. In addition, for reception, each of a plurality of phased array antennas is coupled to one digital signal processing circuit via different analog-to-digital converters (A/Ds).

### CITATION LIST

### Patent Document

[Patent Document 1] Japanese National Publication of International Patent Application No. 2014-530535

### Non Patent Documents

[Non Patent Document 1] J. Zhang, et al., “Massive hybrid antenna array for millimeter-wave cellular communications,” Wireless Communications, IEEE, Vol. 22, No. 1, pp. 79-87, February 2015
[Non Patent Document 2] T. Kim, et al., “Tens of Gbps Support with mmWave Beamforming Systems for Next Generation Communications,” IEEE GLOBECOM, December 2013

### SUMMARY

According to an aspect of the embodiments, a radio communication device including a memory and a processor coupled to the memory and the processor configured to determine a method, among a plurality of methods for beam forming, to be used for forming a first beam for a first terminal and a second beam for a second terminal based on a difference between an emitting direction of the first beam, to be formed, from the radio communication device and an estimated direction of the second terminal from the radio communication apparatus, the estimated direction being estimated based on a received signal from a second terminal, and form the first beam and the second beam based on the determined method

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a radio communicating device according to a related technology;

FIG. 2A is a diagram illustrating an example of arrangement of elements of a localized type array antenna, and FIG. 2B is a diagram illustrating an example of arrangement of elements of an interleaved type array antenna;

FIG. 3 is a diagram illustrating an example of beam patterns formed by respective subarrays of the radio communicating device according to the related technology;

FIG. 4 is a diagram illustrating an example of patterns of radio signals directed to respective terminals which radio signals are emitted by the radio communicating device according to the related technology;

FIG. 5 is a functional block diagram of a radio communicating device according to a first embodiment;

FIG. 6 is a flowchart of assistance in explaining operation of the radio communicating device according to the first embodiment;

FIG. 7 is a diagram illustrating an example of beam patterns formed by respective subarrays of the radio communicating device according to the first embodiment;

FIG. 8 is a diagram illustrating an example of patterns of radio signals directed to respective terminals which radio signals are emitted by the radio communicating device according to the first embodiment;

FIG. 9 is a diagram illustrating an example of a graph indicating relation between accuracy of terminal direction estimation by the radio communicating device according to the first embodiment and a threshold value;

FIG. 10 is a diagram illustrating an example of a graph indicating relation between beam width of the radio communicating device according to the first embodiment and a threshold value;

FIG. 11 is a diagram of a hardware configuration of the radio communicating device according to the first embodiment;

FIG. 12 is a functional block diagram of a radio communicating device according to a second embodiment;

FIG. 13A is a flowchart of assistance in explaining operation of the radio communicating device according to the second embodiment, and FIG. 13B is a flowchart of assistance in explaining operation of the radio communicating device according to the second embodiment;

FIG. 14 is a diagram illustrating an example of a state in which the radio communicating device according to the second embodiment is forming beams directed to terminal groups;

FIG. 15 is a diagram illustrating an example of a state in which the radio communicating device according to the second embodiment is forming beams directed to terminal groups; and

FIG. 16 is a diagram illustrating an example in which direction estimation by a radio communicating device according to another embodiment is performed using an argument in a vertical direction and an argument in a horizontal direction.

### DESCRIPTION OF EMBODIMENTS

An error may occur in estimation of a terminal direction (direction in which a terminal is located from the reference direction of a radio communicating device). When the error occurs, interference with a radio signal sent by a beam directed to the radio communicating device may occur in hybrid beam forming, so that signal quality may be degraded.

In view of the above, it is an object of the present disclosure to form a beam that suppresses a degradation in signal quality of a radio communicating device on a receiving side.

Embodiments will hereinafter be described with reference to the drawings.

### Related Technology

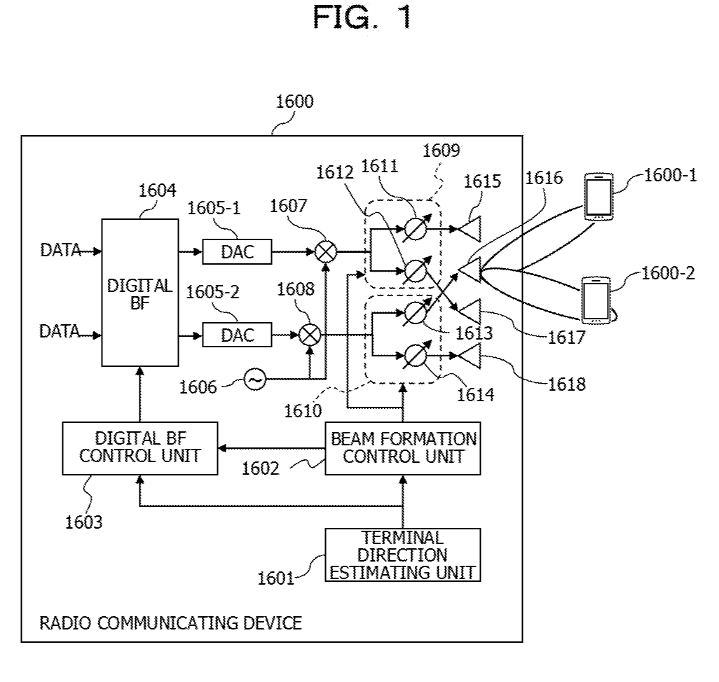

FIG. 1 is a functional block diagram of a radio communicating device of a related technology. A radio communicating device 1600 includes a subarray 1609 formed by elements 1615 and 1617, a subarray 1610 formed by elements 1616 and 1618, a local oscillator 1606, and converters 1607 and 1608. The radio communicating device 1600 also includes digital/analog convertors (DACs) 1605-1 and 1605-2, a digital beam former (BF) 1604, a beam formation control unit 1602, a digital BF control unit 1603, and a terminal direction estimating unit 1601.

The radio communicating device 1600 includes a total of two subarrays, that is, the subarray 1609 and the subarray 1610. Thus, beams formed by the subarrays can be directed to a maximum of two communication destinations, that is, radio communicating devices 1600-1 and 1600-2. Incidentally, the radio communicating device 1600 is assumed to be a base station, and the radio communicating devices 1600-1 and 1600-2 with which the radio communicating device 1600 communicates may be referred to as “terminals.” However, the disclosed contents of the present specification are not limited to being applicable to a radio communicating device communicating with terminals, but are also applicable to a case where a terminal communicating with a base station is used as the radio communicating device 1600.

Incidentally, the number of subarrays is not limited to two. When the number of subarrays of the radio communicating device 1600 is N, the radio communicating device 1600 can form N beams. Hence, for a natural number K equal to or less than N and more than zero, the radio communicating device 1600 can direct beams to K terminals.

In FIG. 1, a line connecting the element 1616 and the subarray 1610 to each other crosses a line connecting the element 1617 and the subarray 1609 to each other. This indicates that an array antenna formed by the subarrays 1609 and 1610 is an interleaved type. An array antenna in which elements belonging to a certain subarray and elements belonging to another subarray are arranged alternately will be referred to as an interleaved type. In addition, an array antenna in which a plurality of elements belonging to a same subarray are arranged so as to be adjacent to each other will be referred to as a localized type.

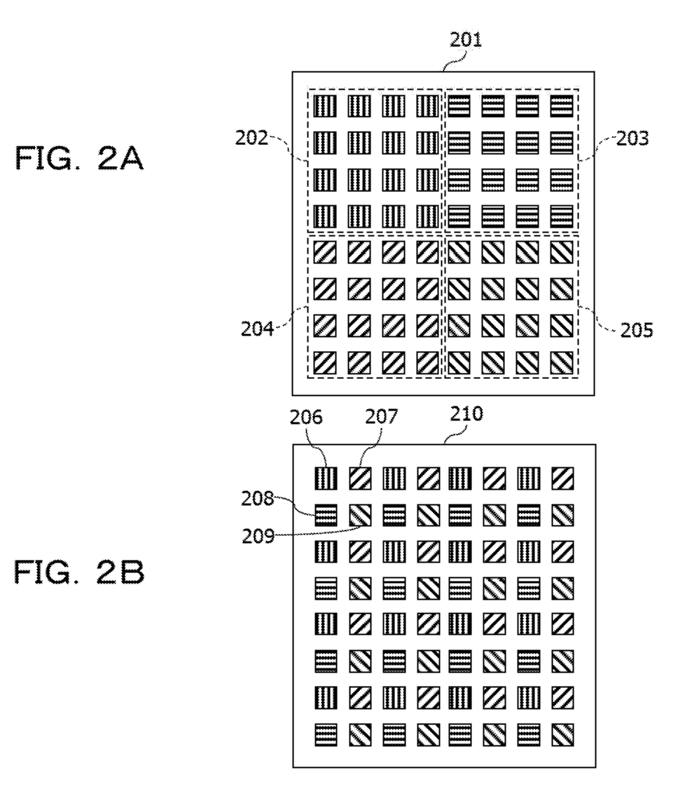

FIG. 2A illustrates an arrangement of elements of a localized type array antenna including four subarrays. Elements of a localized type array antenna 201 belonging to each subarray are arranged adjacent to each other in each of regions 202, 203, 204, and 205. FIG. 2B illustrates an arrangement of elements of an interleaved type array antenna including four subarrays. In FIG. 2B, elements of an interleaved type array antenna 210 provided with same hatching belong to a same subarray. Hence, elements 206, 207, 208, and 209 belonging to different subarrays are arranged alternately.

The array antenna of the interleaved type is effective in multiplexing beams for a plurality of radio communicating devices in hybrid beam forming. Configurations of radio communicating devices including an interleaved type array antenna are depicted in the drawings for the following description. However, the description in the present specification is applicable to radio communicating devices including a localized type array antenna.

The subarrays 1609 and 1610 in FIG. 1 include phase shifters 1611, 1612, 1613, and 1614 coupled to elements 1615, 1617, 1616, and 1618, respectively. The phase shifters 1611, 1612, 1613, and 1614 are controlled by the beam formation control unit 1602 to adjust the phases of radio signals supplied to the elements 1615, 1617, 1616, and 1618, respectively. Beam formation by the array antenna is performed by adjusting the phases.

The converter 1607 generates a radio signal by up-converting the frequency of a baseband signal converted into an analog signal by the DAC 1605-1 to the frequency of an oscillating signal oscillated by the local oscillator 1606. The generated radio signal is output to the subarray 1609. In addition, the converter 1608 generates a radio signal by up-converting the frequency of a baseband signal converted into an analog signal by the DAC 1605-2 to the frequency of the oscillating signal oscillated by the local oscillator 1606. The generated radio signal is output to the subarray 1610.

The DACs 1605-1 and 1605-2 convert the baseband signals output by the digital BF 1604 into the analog signals, and output the analog signals to the converters 1607 and 1608.

The digital BF 1604 subjects each of the baseband signals to digital beam forming, which effects changes in phase and amplitude of each of the baseband by multiplying each of the baseband by a complex signal (weight), according to the control of the digital BF control unit 1603. The digital BF 1604 outputs the baseband signals to the DACs 1605-1 and 1605-2.

The terminal direction estimating unit 1601 estimates a direction (terminal direction) from a reference direction to each of the plurality of terminals 1600-1 and 1600-2. For the estimation of the direction, transmission beams are transmitted in a plurality of directions from an antenna formed by the elements 1615, 1616, 1617, and 1618 or another antenna. The terminal direction estimating unit 1601 then estimates the terminal direction on the basis of a report received from each of the plurality of terminals 1600-1 and 1600-2 that have received the transmission beams.

Each of the transmission beams transmitted in the plurality of directions for example includes information identifying the direction of the transmission beam. Each of the terminals 1600-1 and 1600-2 can therefore report information identifying the direction of a transmission beam from which a maximum received power is obtained to the radio communicating device 1600. The radio communicating device 1600 can estimate that each of the terminals 1600-1 and 1600-2 is located in the transmission direction of the transmission beam from which the maximum received power is obtained.

In addition, times at which the radio communicating device 1600 transmits the transmission beams in the respective directions may be determined in advance, and each of the terminals 1600-1 and 1600-2 may report a time of reception of a transmission beam from which a maximum received power is obtained to the radio communicating device 1600.

The beam formation control unit 1602 controls the phase shifters 1611, 1612, 1613, and 1614 included in the subarrays 1609 and 1610 of the array antenna so as to direct beams in the directions estimated by the terminal direction estimating unit 1601. In addition, the beam formation control unit 1602 outputs information indicating the directions of the beams transmitted from the respective subarrays 1609 and 1610 to the digital BF control unit 1603.

The digital BF control unit 1603 controls the digital BF 1604 on the basis of information indicating the directions estimated by the terminal direction estimating unit 1601 and the information indicating the directions of the beams which information is output by the beam formation control unit 1602. The digital BF control unit 1603 controls the complex signals (weights) by which the baseband signals are multiplied so that, for example, the radio signal of the beam directed to the terminal 1600-2 does not interfere with the radio signal received by the terminal 1600-1. The weights can be calculated by using a zero forcing method, for example.

Operation of the radio communicating device 1600 will be described as follows. In first processing, the terminal direction estimating unit 1601 estimates the directions of the terminals 1600-1 and 1600-2. In second processing, the beam formation control unit 1602 controls the phase shifters 1611, 1612, 1613, and 1614 to direct beams to the respective terminals 1600-1 and 1600-2.

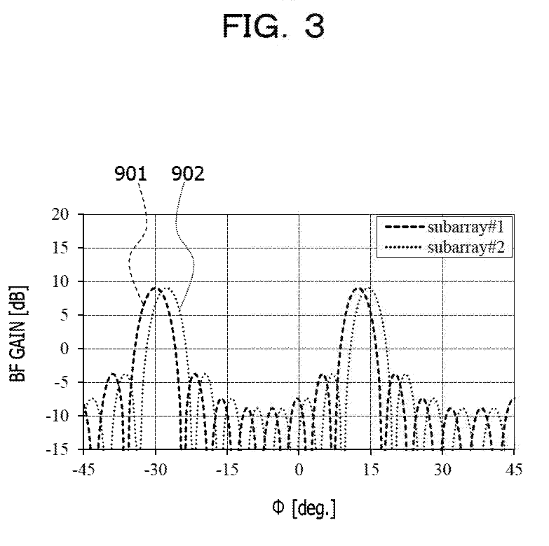

Suppose for example that the terminal direction of the terminal 1600-1 is the direction of an argument of −30 degrees as a horizontal angle with respect to the reference direction, and that the terminal direction of the terminal 1600-2 is the direction of an argument of 15 degrees as a horizontal angle with respect to the reference direction. FIG. 3 is a diagram illustrating an example of a result of simulation of beam patterns formed by respective subarrays of the radio communicating device. As conditions for the simulation, the total number of array antenna elements is 16, and element intervals are 0.7 wavelengths (the same is true for other simulations illustrated in the present specification). As an example, the subarray 1609 is controlled as a subarray 1 (subarray #1) so as to have a beam pattern represented by a graph 901. In addition, the subarray 1610 is controlled as a subarray 2 (subarray #2) so as to have a beam pattern represented by a graph 902. Incidentally, in the graph 901, a peak in a direction of −30 degrees is referred to as a main lobe, and a peak in a direction of 12 degrees is referred to as a grating lobe. In addition, similarly, in the graph 902, a peak in a direction of 15 degrees is referred to as a main lobe, and a peak in a direction of −27 degrees is referred to as a grating lobe.

In other words, a main lobe is a peak formed in the direction in which the beam is directed, and a grating lobe is a peak formed secondarily by forming the main lobe.

Next, in third processing, the digital BF control unit 1603 sets the weights in the digital BF 1604. The setting of the weights is made so that the beam directed to the terminal 1600-2 does not cause interference at the terminal 1600-1 and so that the beam directed to the terminal 1600-1 does not cause interference at the terminal 1600-2.

In fourth processing, radio signals are transmitted to the terminals 1600-1 and 1600-2. Hence, directing the beams to the respective terminals 1600-1 and 1600-2 by the subarrays 1609 and 1610 and individually directing the beams to the terminals 1600-1 and 1600-2 by digital beam forming are performed in an overlapping manner.

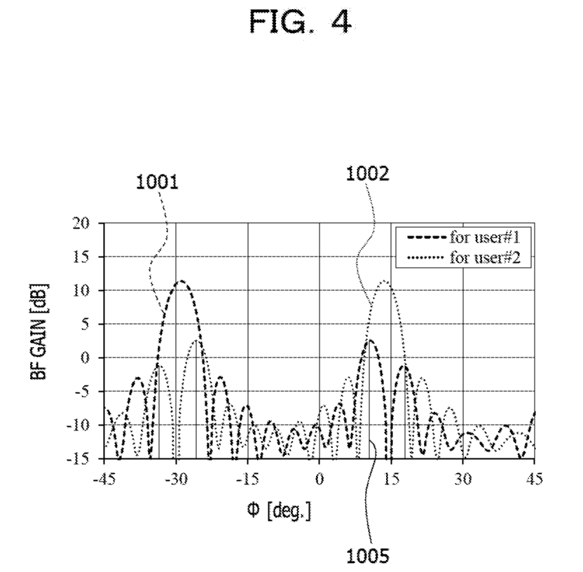

FIG. 4 is a diagram illustrating a result of simulation of patterns of radio signals directed to the respective terminals, which radio signals are emitted by the radio communicating device in the fourth processing. A graph 1001 illustrates the pattern of the radio signal transmitted to the terminal 1600-1. A graph 1002 illustrates the pattern of the radio signal transmitted to the terminal 1600-2. As illustrated in FIG. 4, the strength of the radio signal transmitted to the terminal 1600-2 is zero at the −30 degrees as the terminal direction of the terminal 1600-1. In addition, the strength of the radio signal transmitted to the terminal 1600-1 is zero at the 15 degrees as the terminal direction of the terminal 1600-2.

Here, there may be an error in estimation by the terminal direction estimating unit 1601. The error is caused, for example, due to a fact that angles of transmission directions of the transmission beams for estimating the directions of the terminals are discrete when the transmission beams are scanned. For example, when the scanning is performed in units of a minimum step angle, an error of about the minimum step angle occurs. The error may also be caused by movement of the terminals 1600-1 and 1600-2 after the estimation of the terminal directions, an error at a time of manufacturing of the array antenna, and the like.

Therefore, supposing for example that the terminal direction of the terminal 1600-2 is actually 11 degrees, and not the 15 degrees, which is the estimated direction, the strength of the radio signal transmitted to the terminal 1600-1 is not zero as indicated by a reference numeral 1005, so that interference occurs. That is, the radio signal transmitted to the terminal 1600-2 and the radio signal transmitted to the terminal 1600-1 interfere with each other in the direction in which the terminal 1600-2 is actually located. The reception quality, for example, signal-to-interference noise ratio (SINR) of the terminal 1600-2 is consequently degraded.

Accordingly, description in the following will be made of a technology that suppresses a degradation in reception quality of a terminal even when an error occurs in the estimation of the direction of the terminal.

### First Embodiment

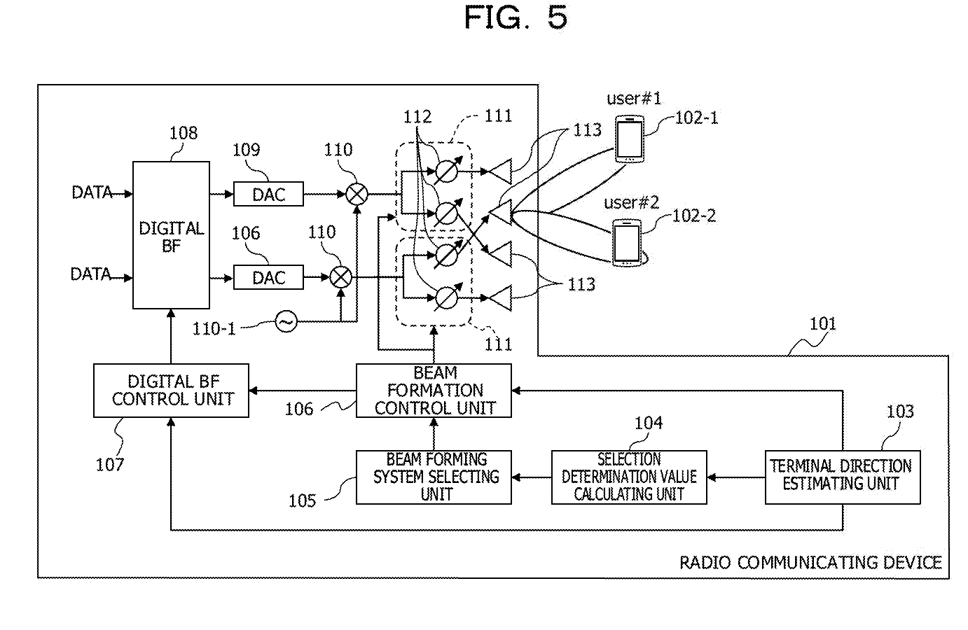

FIG. 5 is functional block diagram of a radio communicating device according to a first embodiment. A radio communicating device 101 includes a plurality of subarrays 111 formed by a plurality of elements 113, a local oscillator 110-1, a plurality of converters 110, and a plurality of DACs 109. The radio communicating device 101 also includes a digital BF 108, a terminal direction estimating unit 103, a selection determination value calculating unit 104, a beam forming system selecting unit 105, a beam formation control unit 106, and a digital BF control unit 107.

The radio communicating device 1600 in the example of FIG. 5 includes two subarrays 111. The radio communicating device 1600 can therefore form a beam directed to each of a maximum of two terminals 102-1 and 102-2. The disclosed contents of the present specification are not limited to being applicable to a radio communicating device communicating with terminals, but are also applicable to a case where a terminal communicating with a base station is used as the radio communicating device.

The number of subarrays is not limited to two. As in the above-described related technology, when the radio communicating device 101 includes N subarrays, the radio communicating device 101 can form N beams. Hence, for a natural number K equal to or less than N and more than zero, formed beams can be directed to K terminals.

In FIG. 5, lines connecting a part of the elements 113 to the two subarrays 111 cross each other. This indicates that, as in the above-described related technology, an array antenna formed by the two subarrays 111 is the interleaved type. The present embodiment is not limited to the interleaved type, but is also applicable to the localized type.

Each of the subarrays 111 includes phase shifters 112 corresponding to the respective elements 113. The phase shifters 112 are controlled by the beam formation control unit 106 to control the phases of radio signals supplied to the elements 113. Beam formation by the array antenna is controlled by the control of the phases.

The converters 110 generate radio signals by up-converting the frequencies of baseband signals converted into analog signals by the DACs 109 to the frequency of an oscillating signal oscillated by the local oscillator 110-1. The generated radio signals are output to the subarrays 111.

The DACs 109 convert the baseband signals output by the digital BF 108 into the analog signals, and output the analog signals to the converters 110.

The digital BF 108 subjects each of the baseband signals to digital beam forming, which effects changes in phase and amplitude of each of the baseband signals by multiplying each of the baseband signals by a complex signal (weight), according to the control of the digital BF control unit 107. The digital BF 108 outputs the baseband signals to the DACs 109.

The terminal direction estimating unit 103 estimates the respective terminal directions of the plurality of terminals 102-1 and 102-2. For the estimation of the direction, transmission beams are transmitted in a plurality of directions from the antenna formed by the elements 113. The terminal direction estimating unit 103 estimates the terminal directions on the basis of reports received from the respective plurality of terminals 102-1 and 102-2 that have received the transmission beams. As described as the above-described related technology, the estimation of the direction can be performed by scanning the transmission beams.

The selection determination value calculating unit 104 calculates a determination value, which is calculated from relation between the directions of a main lobe and a grating lobe and the terminal directions of the terminals 102-1 and 102-2 which terminal directions are estimated by the terminal direction estimating unit 103. Details of the calculation of the determination value will be described later. In addition, the selection determination value calculating unit 104 outputs the calculated determination value to the beam forming system selecting unit 105. The determination value is calculated according to the magnitude of a difference between the direction of a main lobe or a grating lobe when the main lobe is directed to one of a plurality of terminals and a direction in which another terminal is located. For example, the determination value is calculated so as to be a minimum value (for example zero) when a plurality of terminals (for example two terminals) are positioned in the direction of a main lobe or a grating lobe. In addition, the determination value is calculated so as to increase as another terminal goes away from the direction of a main lobe or a grating lobe when a beam is directed to a certain terminal.

Alternatively, the determination value may be calculated so as to assume a maximum value when a plurality of terminals (for example two terminals) are positioned in the direction of a main lobe or a grating lobe. In this case, the determination value can be calculated so as to decrease as another terminal goes away from the direction of a main lobe or a grating lobe when a beam is directed to a certain terminal.

In the following description, in order to simplify description, suppose that the determination value is calculated so as to increase as another terminal goes away from the direction of a main lobe or a grating lobe when a beam is directed to a certain terminal. In the case where the determination value is calculated so as to decrease as another terminal goes away from the direction of a main lobe or a grating lobe when a beam is directed to a certain terminal, the following description can be carried out by reading “equal to or less than a threshold value” as “equal to or more than a threshold value” or the like in the following description.

The beam forming system selecting unit 105 selects a system of beam formation by the subarrays 111 on the basis of the determination value calculated by the selection determination value calculating unit 104. For example, when the determination value is equal to or less than a threshold value, the beam forming system selecting unit 105 selects a first beam forming system as one system of forming beams directed to the terminals for which the determination value is calculated. When the determination value exceeds the threshold value, the beam forming system selecting unit 105 selects a second beam forming system. The following description will be made supposing that there is one threshold value and that there are two beam forming systems. There may be two or more threshold values, and one system may be selected from three or more beam forming systems.

It is assumed in the following that the determination value calculated by the selection determination value calculating unit 104 is calculated so as to increase as another terminal goes away from the direction of a main lobe or a grating lobe when a beam is directed to a certain terminal. Under this assumption, when the determination value is equal to or less than the threshold value, when beams are individually directed to the terminals as described with reference to FIG. 4, and when there is an error in a terminal direction, digital beam forming may cause interference between the beams. Accordingly, when the determination value is equal to or less than the threshold value, a beam formation is performed which directs the beams of the plurality of subarrays in a same direction.

Conversely, it is considered that in a case where the determination value exceeds the threshold value, the interference between the beams does not occur even when there is an error in a terminal direction. This can be understood from a fact that the strength of a signal is decreased at parts separated from a main lobe and a grating lobe in FIG. 3 and the like. Accordingly, when the determination value exceeds the threshold value, the subarrays form beams directed to the respective individual terminals.

Incidentally, when the number K of terminals is smaller than the number N of subarrays, K subarrays may be operated, and N−K subarrays may be stopped from operating. Alternatively, a plurality of subarrays may be used to direct beams to a terminal at a large distance from the radio communicating device 101 to the terminal. In this case, a same signal may be input from the converters 110 to the plurality of subarrays 111 directed to the terminal at the large distance.

The beam formation control unit 106 controls the phase shifters 112 included in the subarrays 111 of the array antenna so as to direct beams in the directions estimated by the terminal direction estimating unit 103 on the basis of the output from the beam forming system selecting unit 105. In addition, the beam formation control unit 106 outputs information indicating the directions of the respective beams to the digital BF control unit 107.

The digital BF control unit 107 controls the digital BF 108 on the basis of information indicating the directions estimated by the terminal direction estimating unit 103 and the information indicating the directions of the beams, the information indicating the directions of the beams being output by the beam formation control unit 106. The digital BF control unit 107 for example controls complex signals (weights) by which the baseband signals are multiplied such that the radio signal of the beam directed to the terminal 102-2 does not interfere with the radio signal received by the terminal 102-1.

The weights are calculated by using a zero forcing method, for example. In addition, weights may be calculated for each estimated direction in advance, and the calculated weights may be stored in association with the estimated directions. In the present embodiment, the weights can be calculated in advance because N is finite, the minimum step angle is finite, and the number of estimated directions of terminals is finite.

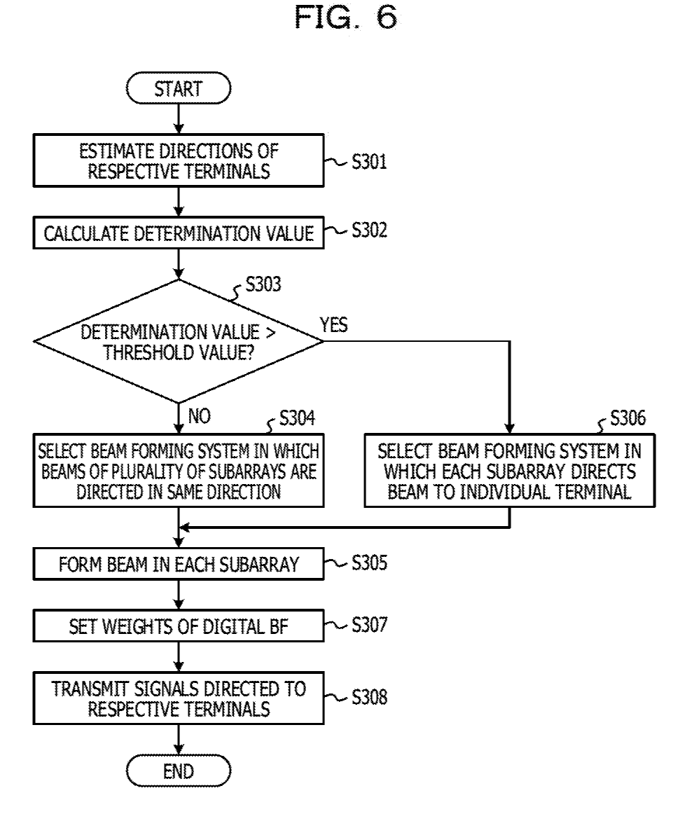

FIG. 6 is a flowchart of processing of the radio communicating device. In step S301, the terminal direction estimating unit 103 estimates the directions of the respective terminals 102-1 and 102-2. In step S302, the selection determination value calculating unit 104 calculates the determination value. In step S303, the determination value and the threshold value are compared with each other. When the determination value is equal to or less than the threshold value, a branch to No occurs, and thus the processing moves to step S304. In step S304, the beam forming system selecting unit 105 selects a beam forming system in which the beams of the plurality of subarrays are directed in a same direction. The processing thereafter moves to step S305.

When the determination value exceeds the threshold value in step S303, a branch to Yes occurs, and thus the processing moves to step S306. In step S306, the beam forming system selecting unit 105 selects a beam forming system in which the subarrays direct the beams to the individual terminals 102-1 and 102-2. The processing then moves to step S305.

In step S305, each of the subarrays 111 forms a beam on the basis of the control of the beam formation control unit 106 according to the beam forming system. In step S307, the digital BF control unit 107 sets the weights for digital beam forming. In step S308, signals directed to the respective terminals 102-1 and 102-2 are transmitted.

The calculation of the determination value will be described in the following. The determination value is defined as a minimum value of the following mathematical expression 1 for a combination of two arbitrary terminals #k and #l from a plurality of terminals with which the radio communicating device 101 communicates.

$${min}_{n ∈ \{ arbitrary integer \}} \vert \vert sin {\hat{φ}}_{l} - sin {\hat{φ}}_{k} \vert - n \frac{λ}{d} \vert \qquad [ Expression 1 ]$$

where λ is the wavelength of a radio signal, d is an interval between elements 113 adjacent to each other, \hat{φ}ₗ is the estimated direction of the terminal #l, and \hat{φ}ₖ is the estimated direction of the terminal #k.

In other words,

$$\vert \vert sin {\hat{φ}}_{l} - sin {\hat{φ}}_{k} \vert - n \frac{λ}{d} \vert \qquad [ Expression 2 ]$$

is calculated for arbitrary #l and #k and an arbitrary integer n, and a minimum value of calculated values can be set as the determination value.

$$\frac{λ}{d} \qquad [ Expression 3 ]$$

is a difference between values obtained by mapping the directions of a main lobe and a grating lobe adjacent to the main lobe by a trigonometric function sin.

$$n \frac{λ}{d} \qquad [ Expression 4 ]$$

is obtained by multiplying the mathematical expression 3 by n other than zero, and is a difference between values obtained by mapping, by a trigonometric function sin, the directions of a main lobe and an nth grating lobe when the main lobe is a zeroth lobe. Hence,

$$\vert \vert sin {\hat{φ}}_{l} - sin {\hat{φ}}_{k} \vert - n \frac{λ}{d} \vert \qquad [ Expression 5 ]$$

becomes a small value when the terminal #k is positioned in a direction near the main lobe or the grating lobe in a case where the main lobe is directed to the terminal #l. Incidentally, because the trigonometric function sin has a value of −1 to 1,

$${min}_{n ∈ \{ arbitrary integer \}} \vert \vert sin {\hat{φ}}_{l} - sin {\hat{φ}}_{k} \vert - n \frac{λ}{d} \vert \qquad [ Expression 6 ]$$

can be calculated by calculating, for a finite number n,

$$\vert \vert sin {\hat{φ}}_{l} - sin {\hat{φ}}_{k} \vert - n \frac{λ}{d} \vert \qquad [ Expression 7 ]$$

Therefore, the mathematical expression 6 can be calculated in a finite time.

In addition, in the case where the array antenna is the interleaved type, the determination value is calculated as a minimum value of the following expression for all of combinations of #l and #k.

$${min}_{n ∈ \{ arbitrary integer \}} \vert \vert sin {\hat{φ}}_{l} - sin {\hat{φ}}_{k} \vert - n \frac{λ}{d} \vert \qquad [ Expression 8 ]$$

N is the number of subarrays. A basis for the above calculation is a fact that in the case of the array antenna of the interleaved type, a difference between values obtained by mapping the directions of a main lobe of a beam formed by a subarray and one of grating lobes (or the main lobe) by a trigonometric function sin is nλ/(Nd).

When the determination value is equal to or less than the threshold value, the subarrays direct the beams in the same direction. In this case, however, the suppression of interference due to digital beam forming becomes important. In the case of the interleaved type, subarray intervals are small as compared with element intervals within the subarrays. It is therefore desirable to avoid a decrease in the determination value when the terminal #k is in positional relation near the main lobe. Accordingly, in the case of the interleaved type, the determination value may be calculated by a minimum value of the following expression for all of #l and #k.

$${min}_{n ∈ \{ arbitrary integer excluding multiple of N \}} \vert \vert sin {\hat{φ}}_{l} - sin {\hat{φ}}_{k} \vert - n \frac{λ}{d} \vert \qquad [ Expression 9 ]$$

The minimum value is calculated excluding cases where n is a multiple of N because the determination value can be decreased when n is a multiple of N and when the terminal #k is in positional relation near the main lobe.

In addition, the direction in which each subarray directs the beam when the determination value is equal to or less than the threshold value may be a direction of an arithmetic mean of arguments of the directions of the terminals. Alternatively, the direction in which each subarray directs the beam when the determination value is equal to or less than the threshold value may be an average of the directions of two terminals for which a maximum value and a minimum value of the following expression are calculated as follows.

$$\vert \vert sin {\hat{φ}}_{l} - sin {\hat{φ}}_{k} \vert - n \frac{λ}{d} \vert \qquad [ Expression 10 ]$$

To decrease differences between the peak directions of the formed beam and the directions of the terminals, the beam is formed in a direction of minimizing a difference between the direction of each terminal and the direction of a nearest lobe that is the grating lobe or the main lobe of the beam formed by the subarray. At this time, in the case of the array antenna of the interleaved type, an index of the nearest grating lobe or main lobe with respect to the direction of the terminal #k when the main lobe is directed in the direction of the terminal #l is obtained by

$${n}_{k} = { arg min}_{n ∈ \{ arbitrary integer \}} \vert sin {\hat{φ}}_{k} - ( sin {\hat{φ}}_{1} + n \frac{λ}{D} ) \vert \qquad [ Expression 11 ]$$

In addition, differences for terminals whose differences in a positive direction (direction in which an argument is positive with respect to the reference direction) and a negative direction are a maximum are each obtained by the following equation.

$${Δ}_{+} = {max}_{k} ( sin {\hat{φ}}_{k} - ( sin {\hat{φ}}_{1} + {n}_{k} \frac{λ}{Nd} ) ) \\ {Δ}_{-} = {min}_{k} ( sin {\hat{φ}}_{k} - ( sin {\hat{φ}}_{1} + {n}_{k} \frac{λ}{Nd} ) ) \qquad [ Expression 12 ]$$

Accordingly,

$$arcsin \{ sin {\hat{φ}}_{1} + \frac{{Δ}_{+} + {Δ}_{-}}{2} ) \qquad [ Expression 13 ]$$

is used as a direction that minimizes the differences for the terminals whose differences are a maximum.

As described above, in the present embodiment, when the determination value is equal to or less than the threshold value, the directions of the beams formed by the subarrays are different from the directions in which the terminals are estimated to be located, and can also be made different from the directions in which the terminals are actually located. A degradation in reception quality can be suppressed also in this manner. In other words, even when an error occurs in estimating a direction in which a terminal is located and the direction of a beam formed by a subarray is different from a direction in which the terminal is actually located, interference by another beam can be suppressed.

The same is true also for the case where the determination value is calculated so as to be a maximum value when a plurality of terminals (for example two terminals) are positioned in the direction of a main lobe or a grating lobe. In other words, when the determination value exceeds the threshold value, the directions of the beams formed by the subarrays are different from the directions in which the terminals are estimated to be located, and can also be made different from the directions in which the terminals are actually located. A degradation in reception quality can be suppressed also in this manner. In other words, even when an error occurs in estimating a direction in which a terminal is located and the direction of a beam formed by a subarray is different from a direction in which the terminal is actually located, interference by another beam can be suppressed.

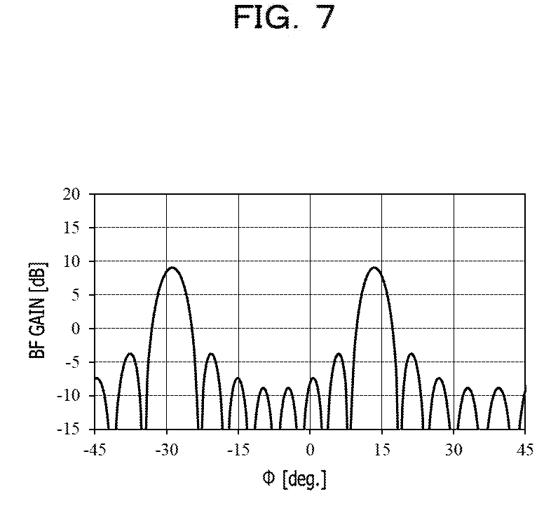

FIG. 7 is a diagram illustrating an example of beam formation in the case where the determination value is equal to or less than the threshold value. In other words, FIG. 7 is a diagram illustrating a result of simulation of a beam pattern formed by each of the subarrays of the radio communicating device in the case where the determination value is equal to or less than the threshold value. Suppose for example that the direction of the terminal 102-1 is the direction of an argument of −30 degrees as a horizontal angle with respect to the reference direction, and that the direction of the terminal 102-2 is the direction of an argument of 15 degrees as a horizontal angle with respect to the reference direction. In this case, when the determination value is equal to or less than the threshold value, all of the subarrays form beams in the same direction, and the main lobes and the grating lobes of all of the beams have the same relation as in FIG. 7.

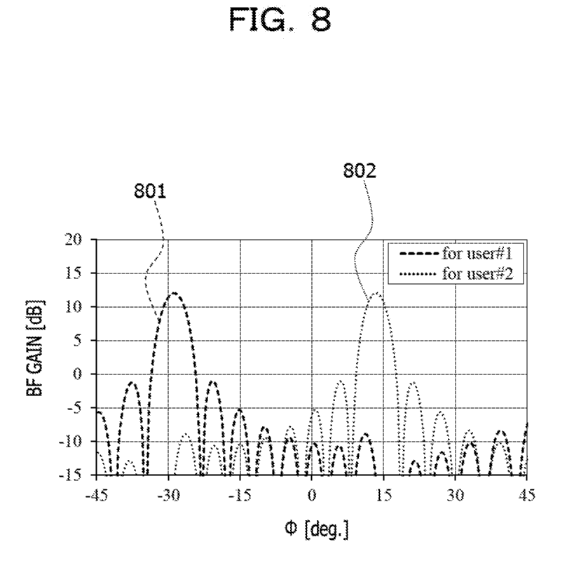

FIG. 8 is a diagram illustrating a result of simulation of patterns of respective radio signals directed to the respective terminals, which radio signals are emitted by the radio communicating device by beam forming. As illustrated in FIG. 8, the interference of the radio signals is small so as to be negligible at −30 degrees (pattern 801) and 15 degrees (pattern 802) as the estimated directions of the respective terminals. In addition, as compared with FIG. 4, the regions of angles at which the interference of the radio signals is small so as to be negligible are larger in FIG. 8 than in FIG. 4. This means that even when an error occurs between the estimated direction of a terminal and the direction in which the terminal is actually located, the interference of the radio signal is suppressed at the actual position of the terminal.

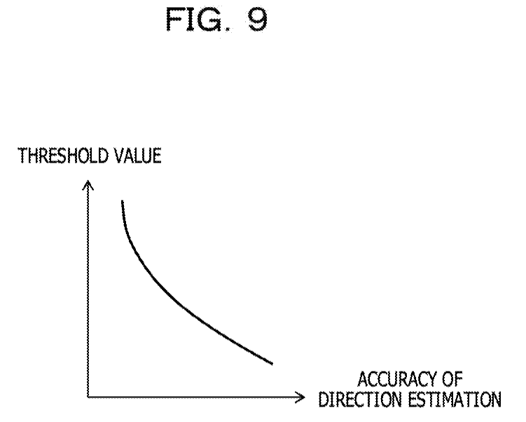

Incidentally, as illustrated in FIG. 9, the threshold value for the determination value for selecting the beam forming system may be changed so as to be increased as accuracy of the direction estimation becomes lower (as the error in the direction estimation is increased) (FIG. 9 is a diagram illustrating an example of a graph indicating relation between accuracy of terminal direction estimation by the radio communicating device according to the first embodiment and a threshold value.). This is because interference tends to occur when the beam formation control unit 106 performs control so as to direct the beams to the individual terminals in a case where there is a large error in the direction estimation.

Incidentally, the accuracy of the terminal direction estimation can be improved as the minimum step angle of the transmission beams scanned for the direction estimation becomes smaller. As the minimum step angle of the transmission beams scanned for the direction estimation becomes smaller, the transmission beams can be transmitted in more directions, and thus the accuracy of the estimation can be increased. The minimum step angle may be determined by the terminal direction estimating unit 103 according to the number of terminals or the like, stored in a memory of the radio communicating device 101 or the like, and read by the beam forming system selecting unit 105.

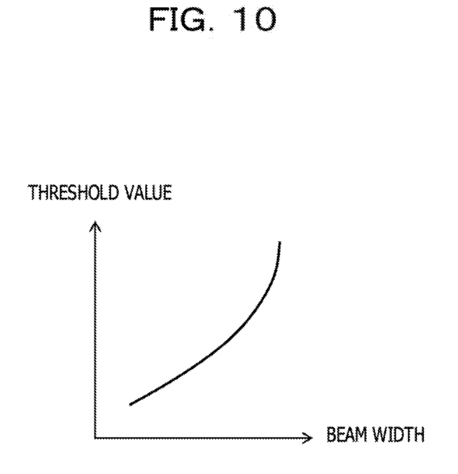

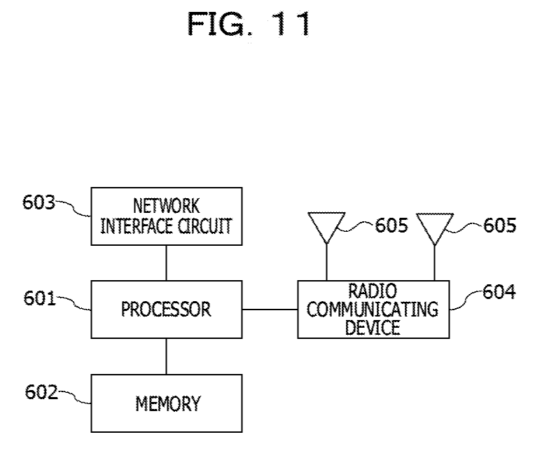

In addition, when the beams formed by the subarrays spread widely, the main lobe of a beam directed to a certain terminal and the grating lobe of a beam directed to another terminal tend to overlap each other. Accordingly, as illustrated in FIG. 10, the threshold value may be changed so as to be increased as the spread of beam width (dimension of width of the shape of the main lobe and the grating lobe in the vicinity of the peaks) is increased (FIG. 10 is a diagram illustrating an example of a graph indicating relation between beam width of the radio communicating device according to the first embodiment and a threshold value.). The beam width may also be stored in the memory of the radio communicating device 101 or the like, and read by the beam forming system selecting unit 105.

FIG. 11 is a diagram of a hardware configuration of the radio communicating device according to the first embodiment. The radio communicating device 101 includes a processor 601, a memory 602, a network interface circuit 603, a radio communicating device 604, and antennas 605.

The processor 601 may be formed by a central processing unit (CPU) and a digital signal processor (DSP). The memory 602 is a volatile memory or a nonvolatile memory. The memory 602 retains a program executed by the CPU, and can provide a work area when the CPU executes the program. Implemented when the program is executed are the terminal direction estimating unit 103, the selection determination value calculating unit 104, the beam forming system selecting unit 105, the beam formation control unit 106, and the digital BF control unit 107. The DSP is a device implementing the digital BF 108. The network interface circuit 603 performs data input and output from and to a communication network such as a core network or the like. The radio communicating device 604 is a device for processing radio signals. The radio communicating device 604 implements the DACs 109, the converters 110, and the phase shifters 112. The antennas 605 are an array antenna including the elements 113. Incidentally, while FIG. 11 depicts two antennas 605, three or more antennas 605 may be provided.

In addition, when the processor 601 is formed by for example a field programmable gate array (FPGA) or the like, the radio communicating device 101 can be formed by hardware without using a program.

### Second Embodiment

In the first embodiment, there can be a case where, when a same beam forming system is used for all of the subarrays, the determination value for a combination of a part of the terminals is small, but the determination value for a combination of the other terminals is large. In this case, all of the subarrays may form the beams in the same direction. Therefore, it can no longer be said that the beams are formed in desired directions, and there is a fear of an increase in the number of terminals that may not obtain a gain from beam forming. Accordingly, as a second embodiment, a method will be described which improves the reception quality of more terminals by grouping combinations of terminals from which small determination values are obtained and selecting a beam forming method for each group.

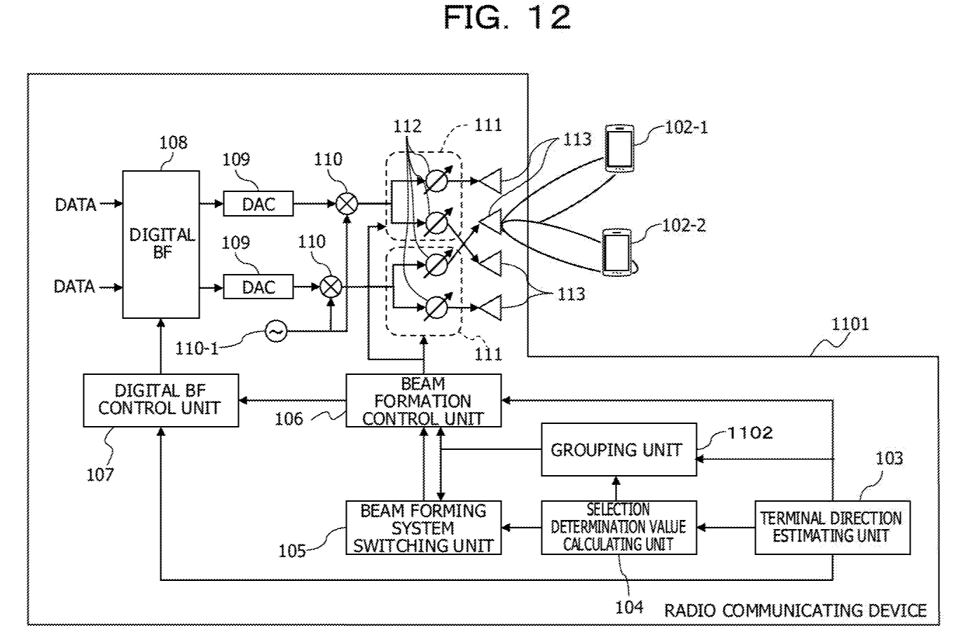

FIG. 12 is a functional block diagram of a radio communicating device according to a second embodiment. A radio communicating device 1101 includes elements 113, subarrays 111, converters 110, DACs 109, and a digital BF 108. The radio communicating device 1101 also includes a terminal direction estimating unit 103, a selection determination value calculating unit 104, a beam forming system selecting unit 105, a beam formation control unit 106, a digital BF control unit 107, and a grouping unit 1102.

The elements 113, the subarrays 111, the converters 110, the DACs 109, the digital BF 108, the terminal direction estimating unit 103, and the digital BF control unit 107 may be configured in an identical or similar manner to those of the radio communicating device 101 according to the first embodiment.

The selection determination value calculating unit 104 calculates a determination value calculated from relation between a main lobe and a grating lobe and the directions of terminals 102-1 and 102-2 which directions are estimated by the terminal direction estimating unit 103. The selection determination value calculating unit 104 outputs the calculated determination value to the beam forming system selecting unit 105. In addition, the selection determination value calculating unit 104 outputs a determination value J_{l,k} for a combination of terminals #l and #k to the grouping unit 1102.

The grouping unit 1102 groups terminals on the basis of the determination value J_{l,k} of the combination of #l and #k, the determination value of the combination being equal to or less than the threshold value. The grouping is performed by selecting a terminal #m different from the terminals #l and #k for the determination value J_{l,k}, calculating J_{k,m} and J_{m,l}, and determining whether each of the values of J_{l,k}, J_{k,m}, and J_{m,l} falls within a given numerical range. As with the threshold value, the given numerical range may be extended as accuracy of direction measurement is degraded, and may be extended as transmission beam width is increased. When each of the values of J_{l,k}, J_{k,m}, and J_{m,l} falls within the given numerical range, #m is added to the group of #l and #k to enlarge the group and thus create a new group. Subsequently, in a similar manner, a terminal not belonging to the thus created group is selected, and the group can be enlarged. Incidentally, for a terminal not belonging to any group, a group whose member is limited to the terminal may be formed.

The grouping unit 1102 outputs information about the created groups to the beam forming system selecting unit 105 and the beam formation control unit 106. The information about the created groups includes the identification numbers of the terminals belonging to each group. The information about the created groups may also include a minimum value of the determination values of combinations of the terminals belonging to each group.

The beam forming system selecting unit 105 selects a beam forming system for each group on the basis of the output of the selection determination value calculating unit 104 and the grouping unit 1102. For example, when two or more terminals belong to a group, and the determination value(s) is (are) equal to or less than the threshold value, the number of subarrays which number corresponds to the number of terminals belonging to the group are made to form beams in the same direction. When one terminal belongs to a group, or the determination value(s) exceed(s) the threshold value, a subarray is made to form an individual beam directed to the terminal belonging to the group.

The beam formation control unit 106 controls the subarrays 111 so that beam formation selected for each group is performed on the basis of the output from the beam forming system selecting unit 105 and the grouping unit 1102.

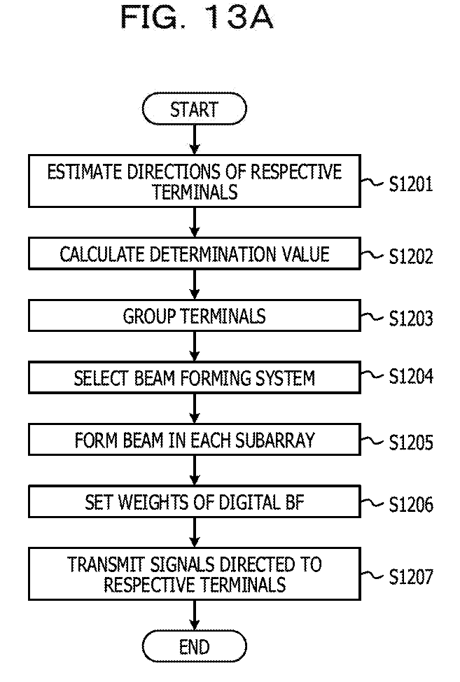

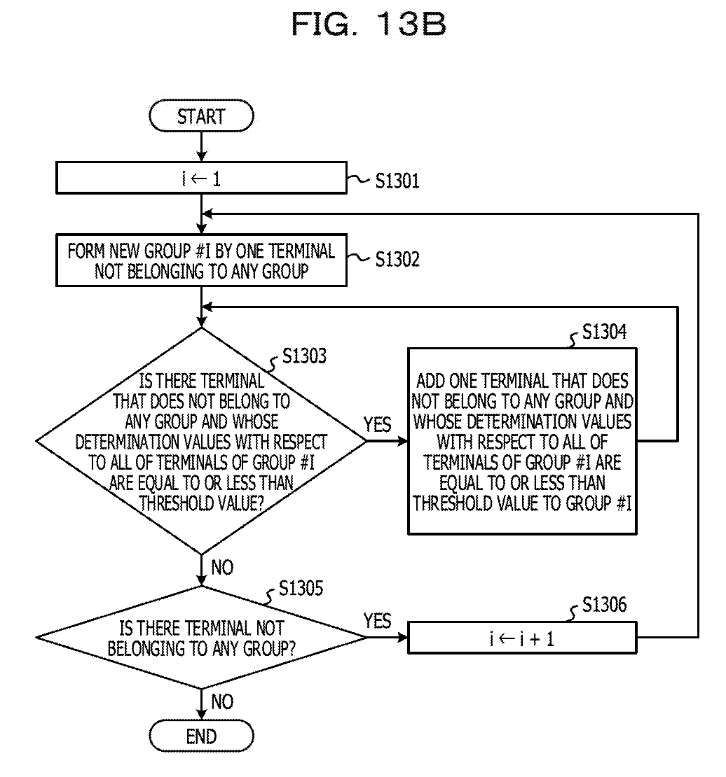

FIG. 13A is a flowchart of operation of the radio communicating device according to the second embodiment. In step S1201, the terminal direction estimating unit 103 estimates the directions of the respective terminals 102-1 and 102-2. In step S1202, the selection determination value calculating unit 104 calculates the determination value. In step S1203, the grouping unit 1102 groups the terminals. In step S1204, the beam forming system selecting unit 105 selects a beam forming system. In step S1205, each subarray 111 forms a beam on the basis of the control of the beam formation control unit 106 according to the beam forming method. In step S1206, the digital BF control unit 107 sets weights for digital beam forming. In step S1207, the radio communicating device 1101 transmits signals directed to the respective terminals 102-1 and 102-2.

FIG. 13B is a flowchart illustrating details of processing of grouping terminals in step S1203 of FIG. 13A. In step S1301, initialization is performed by assigning one to a variable i. The variable i is used to indicate a terminal group. In step S1302, the radio communicating device 1101 creates a new group #i formed by one terminal not belonging to any group. In other words, one terminal not belonging to any group is selected, and the new group #i is created by the selected terminal. Incidentally, when no group is created (in other words, when i=1), one terminal is selected, and the new group #i is created by the selected terminal.

In step S1303, the radio communicating device 1101 determines whether there is a terminal that does not belong to any group and whose determination values with respect to all of the terminals of the group #i are equal to or less than the threshold value. When there is a terminal that does not belong to any group and whose determination values with respect to all of the terminals of the group #i are equal to or less than the threshold value, the radio communicating device 1101 shifts the processing to step S1304 (in step S1303, the radio communicating device 1101 branches the processing to Yes). When there is no terminal not belonging to any group or there is no terminal whose determination values with respect to all of the terminals of the group #i are equal to or less than the threshold value, the radio communicating device 1101 shifts the processing to step S1305 (in step S1303, the radio communicating device 1101 branches the processing to No).

In step S1304, the radio communicating device 1101 adds one terminal that does not belong to any group and whose determination values with respect to all of the terminals of the group #i are equal to or less than the threshold value to the group #i. The radio communicating device 1101 returns the processing to step S1303.

In step S1305, the radio communicating device 1101 determines whether there is a terminal that does not belong to any group. When there is a terminal that does not belong to any group, the radio communicating device 1101 shifts the processing to step S1306 (in step S1305, the radio communicating device 1101 branches the processing to Yes). When there is no terminal that does not belong to any group, the radio communicating device 1101 ends the processing of the flowchart of FIG. 13B (in step S1305, the radio communicating device 1101 branches the processing to No).

In step S1306, the radio communicating device 1101 adds one to the value of the variable i, and assigns the resulting value as a new value of the variable i. The radio communicating device 1101 returns the processing to step S1302.

As a result of the above processing of the flowchart of FIG. 13B, each terminal belongs to one of groups.

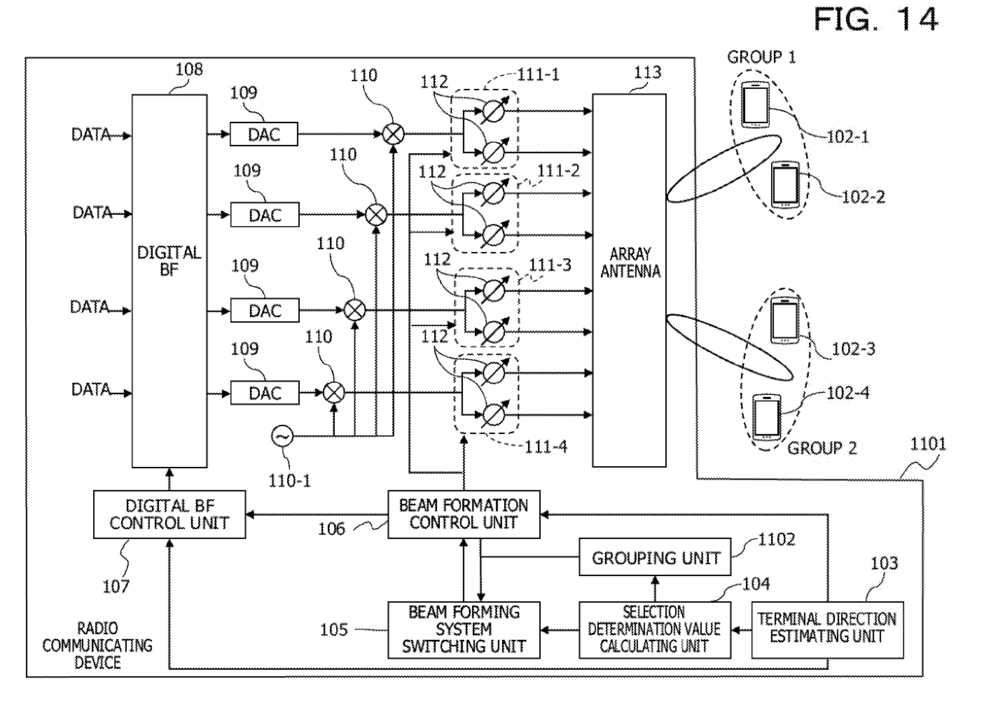

FIG. 14 is a diagram illustrating an example of a state in which the radio communicating device according to the second embodiment is forming beams directed to terminal groups. As depicted in FIG. 14, terminals 102-1 and 102-2 form a terminal group 1, terminals 102-3 and 102-4 form a terminal group 2, and beams in the same direction are directed from a plurality of subarrays to each of the groups 1 and 2.

For example, a subarray 111-1 forms a beam in a direction determined by the direction of the group 1, and a subarray 111-2 forms a beam in a direction determined by the direction of the group 2.

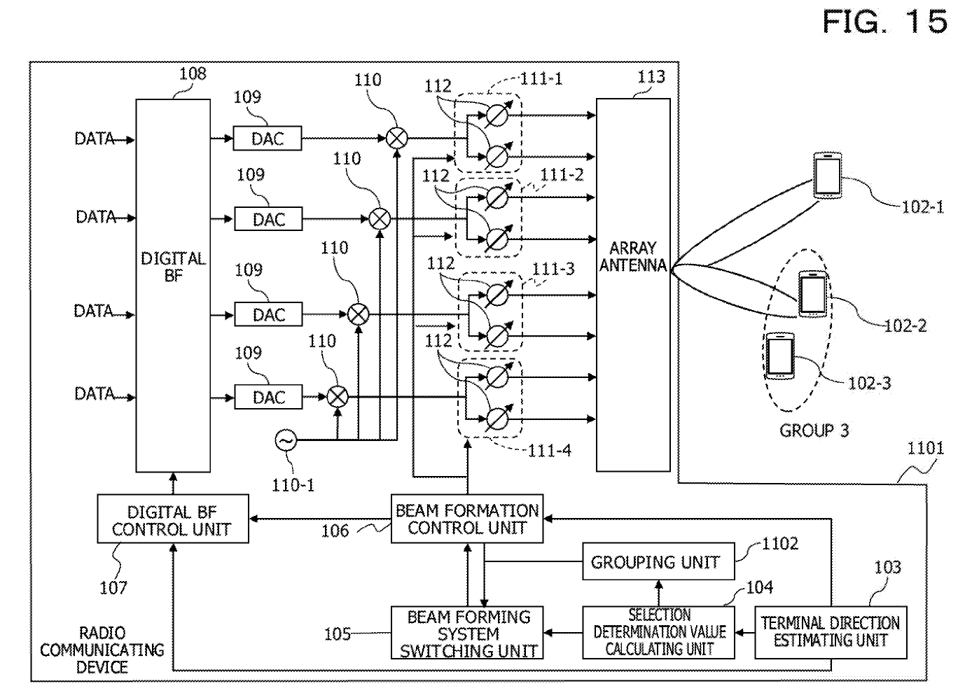

The number of terminals is not limited to an even number. As illustrated in FIG. 15, the number of terminals may be an odd number (FIG. 15 is a diagram illustrating an example of a state in which the radio communicating device according to the second embodiment is forming beams directed to terminal groups.). In this case, one terminal 102-1 forms one group, and a subarray 111-3 forms a beam in a direction different from the direction of a beam formed by another subarray 111-4. In addition, terminals 102-2 and 102-3 form a group 3, and the subarray 111-4 directs the beam in the direction of the group 3.

### OTHER EMBODIMENTS

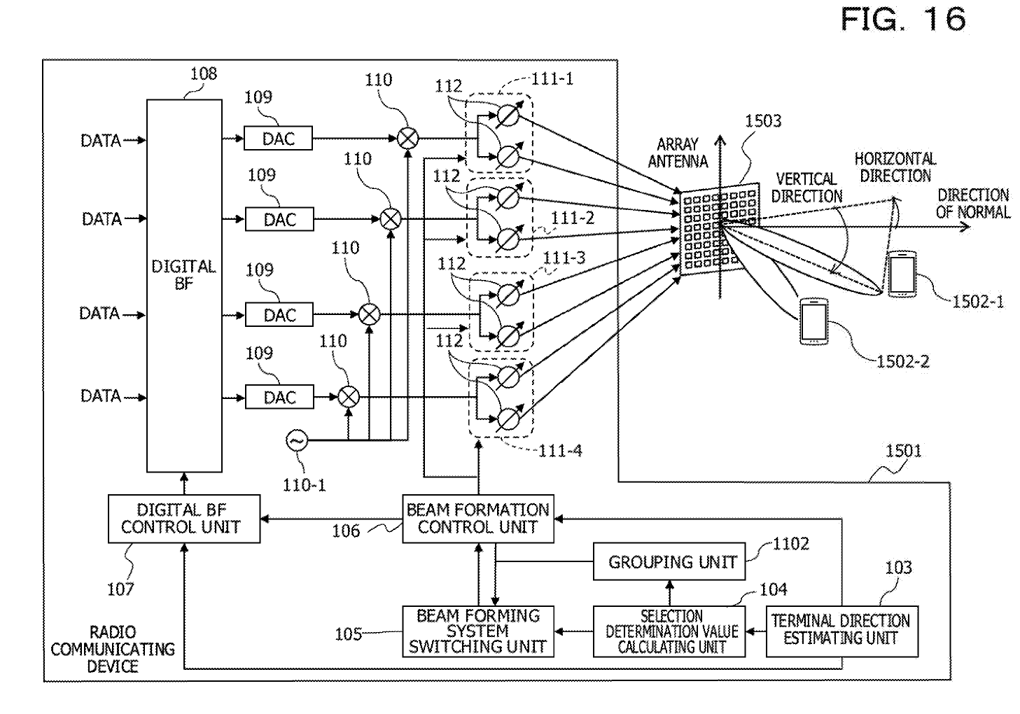

In the above description, the direction of a terminal is indicated mainly by an argument in the horizontal direction from the reference direction, but may be indicated by an argument in a vertical direction from the reference direction. In addition, as illustrated in FIGS. 2A and 2B, when elements are arranged two-dimensionally, the direction of a terminal can be indicated by a combination of both of an argument in the horizontal direction and an argument in the vertical direction toward the terminal direction. In other words, as illustrated in FIG. 16, with the direction of a normal to an array antenna 1503 as a reference, arguments in the vertical direction and the horizontal direction toward each of terminals 1502-1 and 1502-2 can be estimated as a terminal direction (FIG. 16 is a diagram illustrating an example in which direction estimation by a radio communicating device according to another embodiment is performed using an argument in a vertical direction and an argument in a horizontal direction.).

In this case, when both of determination values calculated for the horizontal direction and the vertical direction, individually, are equal to or less than the threshold value, a plurality of subarrays may be made to form beams in the same direction. Incidentally, values different for the horizontal direction and the vertical direction, individually, can be used as the threshold value. In addition, changes in the threshold value according to an error in terminal direction estimation may be made to differ between the horizontal direction and the vertical direction. In addition, changes in the threshold value according to beam width may be made to differ between the horizontal direction and the vertical direction.

In addition, in the foregoing, description has been made of a case where radio signals are transmitted from the radio communicating devices 101, 1101, and 1501 to the terminals 102-1 to 102-4 and 1502-1 and 1502-2. However, the present technology is similarly applicable to cases where the radio communicating devices 101, 1101, and 1501 receive radio signals from the terminals 102-1 to 102-4 and 1502-1 and 1502-2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication device comprising:
a memory; and
a processor coupled to the memory and the processor configured to:
determine a method, among a plurality of methods for beam forming, to be used for forming a first beam for a first terminal and a second beam for a second terminal based on a difference between an emitting direction of the first beam, to be formed, from the radio communication device and an estimated direction of the second terminal from the radio communication apparatus, the estimated direction being estimated based on a received signal from a second terminal; and
form the first beam and the second beam based on the determined method.

2. The radio communicating device according to claim 1, wherein
the processor is configured to:
calculate a determination value indicating the difference, the calculated determination value assumes a minimum value when the emitting direction of the first beam is identical to the estimated direction of the second terminal, and increases as the difference becomes increase.

3. The radio communicating device according to claim 1, wherein
the processor is configured to:
calculate a determination value indicating the difference, the calculated determination value assumes a maximum value when the emitting direction of the first beam is identical to the estimated direction of the second terminal, and decreases as the difference becomes decrease.

4. The radio communicating device according to claim 1, wherein
the processor is configured to:
form the first beam for an estimated direction of the first terminal and form the second beam for an estimated direction of the second terminal when the difference exceeds a threshold, the estimated direction of the first terminal being estimated based on a received signal from the first terminal; and
form the first beam and the second beam for a same direction when the difference is equal to or less than the threshold.

5. The radio communicating device according to claim 1, further comprising:
a first subarray; and
a second subarray; wherein
the processor is configured to:
form the first beam by using the first subarray; and
form the second beam by using the second subarray.

6. The radio communicating device according to claim 1, wherein
the processor is configured to:
classify a plurality of terminals into at least one group, a plurality of specified terminals, among the plurality of terminals, being classified into a same group when a difference between estimated directions of each of the plurality of specified terminals is equal to or less than a second threshold; and
determine a method, for beam forming, for each of the at least one group.

7. The radio communicating device according to claim 2, wherein
the larger an error in the estimated direction, the larger a value to which the threshold value is set.

8. The radio communicating device according to claim 3, wherein
the larger an error in the estimated direction, the smaller a value to which the threshold value is set.

9. The radio communicating device according to claim 2, wherein
the larger a spread of beam width of the first beams or the second beam, the larger a value to which the threshold value is set.

10. The radio communicating device according to claim 3, wherein
the larger a spread of beam width of the first beams or the second beam, the smaller a value to which the threshold value is set.

11. The radio communicating device according to claim 5, wherein
the processor is configured to:
estimate the estimated direction of the second terminal in each of a horizontal direction and a vertical direction with respect to a direction of a normal to the first subarray; and
calculate the difference in each of the horizontal direction and the vertical direction with respect to the direction of the normal to the first subarray.

12. A beam control method executed by a radio communication device, the beam control method comprising:
determining a method, among a plurality of methods for beam forming, to be used for forming a first beam for a first terminal and a second beam for a second terminal based on a difference between an emitting direction of the first beam, to be formed, from the radio communication device and an estimated direction of the second terminal from the radio communication apparatus, the estimated direction being estimated based on a received signal from a second terminal; and
forming the first beam and the second beam based on the determined method.
